(19) United States
(12) Patent Application Publication
(10) Pub. No.: US 2012/0156639 A1
(43) Pub. Date: Jun. 21, 2012

(54) GYPSUM TRAY

(76) Inventor: CHIH-CHIANG SU, Yonghe City (TW)

(21) Appl. No.: 12/972,520

(22) Filed: Dec. 20, 2010

(51) Int. Cl. A61C 9/00

(52) U.S. Cl. 433/48

(57) ABSTRACT

An improved gypsum tray is provided, which includes a body. The body has an indented accommodation basin, and gypsum is poured into the accommodation basin to form a tooth mold. The present invention can join a fixing base to a bottom of the body, and the improved gypsum tray is installed on the fixing base of the gypsum tray through the fixing base. Also, after the gypsum forms the tooth mold in the accommodation basin, the fixing base can be joined to a bottom face of the tooth mold. When the tooth mold is installed on the fixing base of the gypsum tray through the fixing base, an angle may be adjusted optionally, thereby solving the problem that an angle cannot be adjusted during a conventional rectifying operation of a tooth mold.

### BACKGROUND OF THE INVENTION

(a) Technical Field of the Invention

The present invention relates to a design of a gypsum tray, and more particularly to an improved gypsum tray for making a tooth mold.

(b) Description of the Prior Art

Most of the conventional gypsum tray structures for making a tooth mold only have a body, and the body has an accommodation basin for accommodating gypsum thereon. The finished tooth mold is placed in an occluder during use, so as to perform an inspection procedure on the occlusion of the tooth mold.

However, as for the above-mentioned gypsum tray, since it only has an accommodation basin, more gypsum is needed to make a tooth mold. Also, the finished tooth mold is not reusable, thus causing a great waste of gypsum. Moreover, an angle of the gypsum tooth mold cannot be adjusted due to its structure.

Therefore, some relevant manufacturers design an improved gypsum tray to solve the above problem. The improved gypsum tray structure has a material-saving area in the accommodation basin to reduce the usage of gypsum.

### SUMMARY OF THE INVENTION

Although an improved gypsum tray mentioned above can reduce the usage of gypsum, the gypsum may easily be separated from the gypsum tray and thus fall off after the gypsum is cured into a tooth mold. Moreover, an angle of the conventional gypsum tooth mold cannot be adjusted due to its structure, which causes problems in use.

Therefore, an aim of the present invention is to provide an improved gypsum tray. The tooth mold made by the gypsum tray is joined to a fixing base provided by the present invention, and any desired angle can be obtained through adjustment during use.

Another aim of the present invention is to provide an improved gypsum tray. The problem that the tooth mold is separated from the gypsum tray and thus falls off can be avoided by the fact that the gypsum tray provided by the present invention has a plurality of fastening members fastened to the tooth mold.

The improved gypsum tray, which can achieve the above aims of the present invention, includes a body. The body has an indented accommodation basin, and the accommodation basin has a bottom and an inner wall extending upwards from the bottom. Gypsum is poured into the accommodation basin, so that the gypsum forms a tooth mold in the accommodation basin.

The present invention further includes a fixing base. The fixing base has an adsorbing element and a joint portion, and the fixing base is selectively joined to the body or the tooth mold.

By means of the technical manner used by the present invention, after gypsum forms the tooth mold in the gypsum tray provided by the present invention, the tooth mold is joined to the fixing base. Since the fixing base has a fixing joint portion, which can adjust an angle according to the needs of a user after the fixing base is joined to an occluder, the problem that an angle of a conventional tooth mold cannot be adjusted is solved.

### BRIEF DESCRIPTION OF THE DRAWINGS

FIG. 1 is a three-dimensional view of a first embodiment of the present invention.

FIG. 2 is a schematic view of the first embodiment illustrating that gypsum is poured into an accommodation basin.

FIG. 3 is a schematic view of the first embodiment illustrating that a tooth mold is separated from a fixing base.

FIG. 4 is a schematic view of the first embodiment illustrating that a tooth mold is joined to a fixing base.

FIG. 5 is a schematic view of a second embodiment of the present invention.

FIG. 6 is a schematic view illustrating a fastening action of a fastening member.

### DETAILED DESCRIPTION OF THE PREFERRED EMBODIMENTS

The other features, advantages and effects of the present invention can be more fully understood, with reference made to the accompanying drawings described in detail hereinafter.

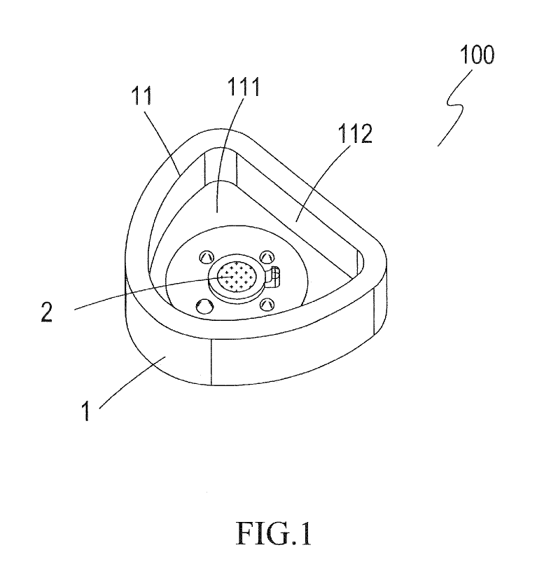

Referring to FIG. 1, FIG. 1 is a three-dimensional view of a first embodiment of the present invention. As shown in this figure, an improved gypsum tray 100 of the present invention includes a body 1, the body has an indented accommodation basin 11, and the accommodation basin 11 has a bottom 111 and an inner wall 112 extending upwards from the bottom 111. The accommodation basin 11 is D-shaped, and gypsum is poured into the accommodation basin 11. In addition, the bottom 111 of the accommodation basin 11 has an adsorbing element 2.

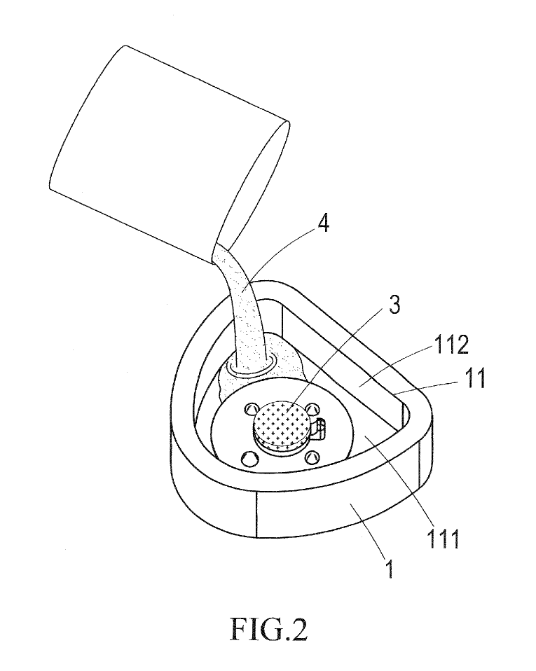

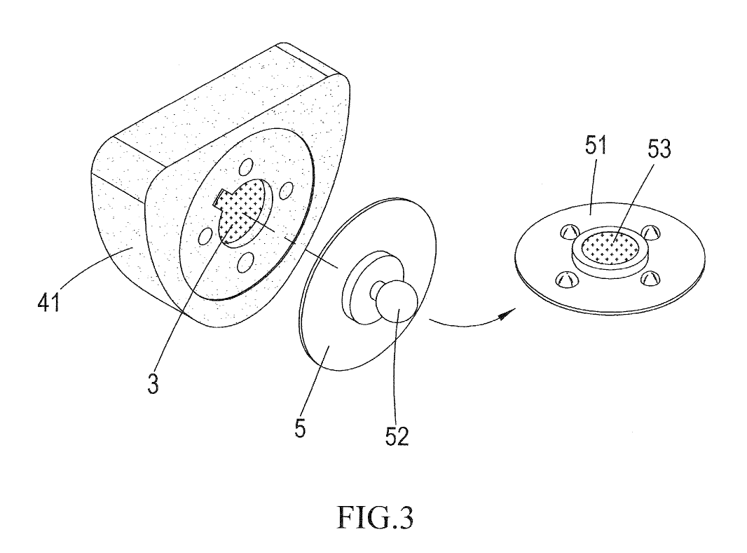

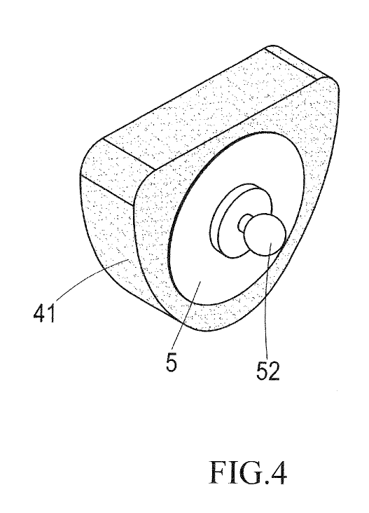

Referring to FIGS. 2-4, FIG. 2 is a schematic view of the first embodiment illustrating that gypsum is poured into an accommodation basin, FIG. 3 is a schematic view of the first embodiment illustrating that a tooth mold is separated from a fixing base, and FIG. 4 is a schematic view of the first embodiment illustrating that a tooth mold is joined to a fixing base. As shown in these figures, when the present invention is implemented, an adsorbate element 3 is placed corresponding to the adsorbing element 2 of the accommodation basin 11, and then gypsum 4 is poured into the accommodation basin 11 of the body 1. After the gypsum 4 is cured in the accommodation basin 11 to form a tooth mold 41, the tooth mold 41 can be taken out from the accommodation basin 11. In this case, the adsorbate element 3 is joined to a bottom of the tooth mold 41.

The present invention further includes a fixing base 5 which is joined to the tooth mold 41. The fixing base 5 has a joint face 51 at one side and a joint portion 52 at the other side. The joint face 51 has an adsorbing element 53, and the joint portion 52 is ball-shaped.

After the tooth mold 41 is taken out from the accommodation basin 11, the joint face 51 of the fixing base 5 can be joined to the tooth mold 41, and then the adsorbing element 53 of the fixing base 5 correspondingly adsorbs the adsorbate element 3 of the tooth mold 41. After the fixing base 5 is joined to the tooth mold 41, the tooth mold 41 can be placed in a tooth mold occlusion rectifier (not shown) through the fixing base 5. Herein, the fixing base 5 is placed in the tooth mold occlusion rectifier by means of its joint portion 52. After the fixing base 5 is placed in the tooth mold occlusion rectifier, an angle of the tooth mold 41 can be adjusted optionally according to the needs of a user through the ball-shaped design of the joint portion 52.

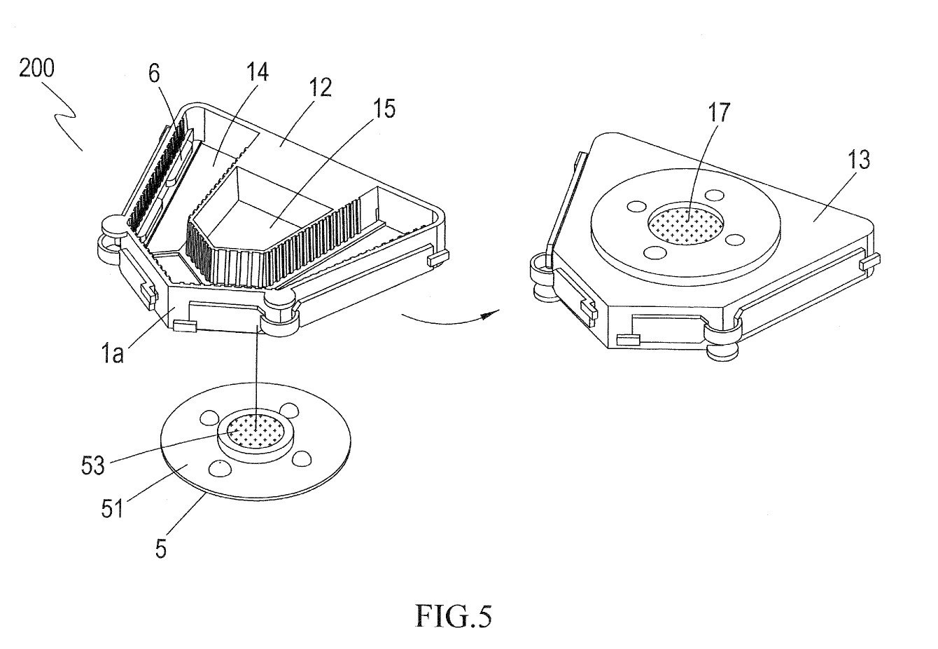

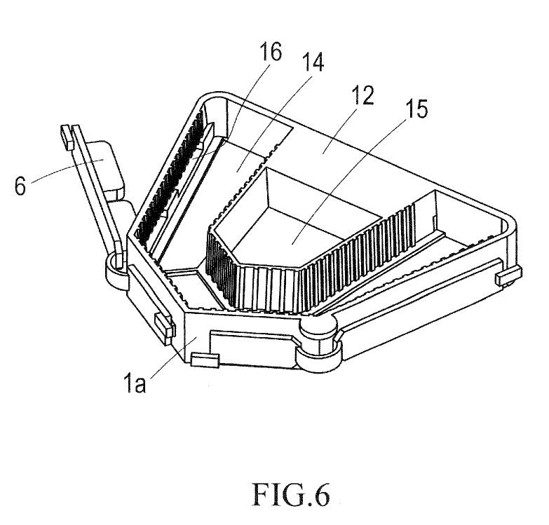

Referring to both FIG. 5 and FIG. 6, FIG. 5 is a schematic view of a second embodiment of the present invention, and FIG. 6 is a schematic view illustrating a fastening action of a fastening member. As shown in these figures, an improved gypsum tray 200 of this embodiment includes a body la, and the body 1a has atop face 12 and a bottom face 13. The top face 12 of the body 1a has an indented accommodation basin 14, and the accommodation basin 14 has a material-saving area 15 therein. A peripheral side of the accommodation basin 14 has a plurality of fastening holes 16, and the bottom face 13 of the body 1a has an adsorbate element 17.

The accommodation basin 14 is approximately U-shaped, and gypsum 4 is poured into the accommodation basin 14, so that the gypsum is cured in the accommodation basin 14 to form a tooth mold 41. The material-saving area 15 is used to reduce the usage of the gypsum 4.

The improved gypsum tray 200 of the embodiment further includes a fixing base 5 and a plurality of fastening members 6. The fixing base 5 has a joint face 51 and a joint portion 52, wherein the joint face 51 has an adsorbing element 53, which can correspondingly adsorb the adsorbate element 17 of the bottom face 13 of the body 1a. The plurality of fastening members 6 are correspondingly fastened in the fastening holes 16 of the body 1a, so that the fastening members 6 can be fastened to the tooth mold 41 after the gypsum 4 forms the tooth mold 41 in the body 1a, thereby avoiding the fall-off of the tooth mold 41 during use.

Since the using manner and the operation principle of this embodiment are the same as those of the first embodiment, no further description will be given here.

I claim:

1. An improved gypsum tray, comprising a body, wherein the body has an indented accommodation basin, the accommodation basin has a bottom and an inner wall extending upwards from the bottom, and the bottom of the accommodation basin has an adsorbing element;
wherein, gypsum is poured into the accommodation basin, so that the gypsum forms a tooth mold in the accommodation basin, and the tooth mold has an adsorbate element which is selectively adsorbed by the adsorbing element.

2. The improved gypsum tray of claim 1, further comprising a fixing base, wherein the fixing base has a joint face at one side and a joint portion at the other side, and the joint face has an adsorbing element which correspondingly adsorbs the adsorbate element when the fixing base is joined to the tooth mold.

3. The improved gypsum tray of claim 2, wherein the accommodation basin of the body is D-shaped.

4. An improved gypsum tray, comprising a top face and a bottom face, wherein the top face of the body has an indented accommodation basin, the accommodation basin has a material-saving area, and the bottom face of the body has an adsorbate element.

5. The improved gypsum tray of claim 4, further comprising a plurality of fastening members, wherein the body has a plurality of fastening holes, and the plurality of fastening members are fastened in the plurality of fastening holes.

6. The improved gypsum tray of claim 5, further comprising a fixing base, wherein the fixing base has a joint face at one side and a joint portion at the other side, and the joint face has an adsorbing element which correspondingly adsorbs the adsorbate element when the fixing base is joined to the bottom face of the body.

7. The improved gypsum tray of claim 6, wherein the accommodation basin of the body is approximately U-shaped.
